(19) United States
(12) Patent Application Publication
(10) Pub. No.: US 2024/0395011 A1
(43) Pub. Date: Nov. 28, 2024

(54) METHOD AND DEVICE FOR ASCERTAINING WHETHER A SPECIFIED IMAGE DETAIL OF A FIRST IMAGE OCCURS IN A SECOND IMAGE

(71) Applicant: Robert Bosch GmbH, Stuttgart (DE)

(72) Inventor: Stephan Simon, Sibbesse (DE)

(21) Appl. No.: 18/664,487

(22) Filed: May 15, 2024

(30) Foreign Application Priority Data
May 26, 2023 (DE) 10 2023 204 988.0
Jun. 1, 2023 (DE) 10 2023 205 147.8

(51) Int. Cl. G06V 10/75; G06V 10/44

(52) U.S. Cl. CPC G06V 10/751; G06V 10/44

(57) ABSTRACT

A method for ascertaining whether a specified image detail of a first image appears in a second image. The method begins with ascertaining at least one image feature for a plurality of pixels within the specified image detail. This is followed by ascertaining at least one image feature for a plurality of pixels of the second image. This is followed by comparing the ascertained image features of the second image with the ascertained image features of the first image to determine whether the two have an identical value. In the method, a rotationally symmetrical area is determined from the second image and this area is transformed into a rectangular area and in that the image features of the pixels of the second image are calculated from pixels within the transformed area.

### FIELD

The present invention relates to a method for ascertaining whether a specified image detail of a first image occurs in a second image, as well as to a device, a computer program and a machine-readable storage medium.

### BACKGROUND INFORMATION

In production, for example of supplier parts for the automotive industry, complete traceability of the individual parts used is increasingly sought, sometimes even required by law or standard.

This traceability enables faster and more precise conclusions to be drawn about origins, for example in the event of malfunctions. For example, it is therefore possible to ascertain the machine used for manufacture and the process parameters used. It is also possible to ascertain or narrow down other supplier parts affected by the defect and to limit a recall to the end products actually affected.

This traceability in production can be practically ensured by:
a. Marking the relevant individual part, today often with a DMC, see de.wikipedia.org/wiki/DataMatrix-Code, e.g., as laser engraving, needle embossing, imprinting or a sticker.
b. Markerless tracking based on the individual surface texture of the individual part.

In both cases, a sensor, such as a camera, captures the part to be tracked at a predetermined location on the surface in order to automatically read the DMC or capture the texture. The texture is then compared with the texture previously captured at approximately the same location and stored (e.g., in a database with a unique index) for all parts in question. In other words, the database comparison mentioned above compares a current “query” image with previously captured reference images.

The texture comparison gives a high match if it is the same part and otherwise a very low match. For example, comparisons are made with 100, 10,000 or 1 million parts. As a rule, the comparison must be carried out in a cycle-neutral manner, i.e., sufficiently quickly so as not to slow down the production cycle, for example 10,000 comparisons in a maximum of 200 ms. Markerless tracking has several advantages:
i. Saving effort, expenses, investments. For example, a laser engraving device is much more expensive, especially to procure, than a camera including lighting for texture capture.
ii. Laser engraving DMCs produces smoke residue, i.e., flakes from the surface that can contaminate the component (e.g., a nozzle) and thus impair its functionality. In contrast, markerless tracking is completely clean.
iii. Some components are too small or do not have a suitable area for applying the DMC, while even the smallest areas of 1 mm² are sufficient for texture capture.
iv. While the DMC can also be read and used by unauthorized persons with malicious intent, this is not possible with the texture, because only the manufacturer itself knows the assignment of the texture. This makes the method more secure.
v. Protection against counterfeiting. While a counterfeit part can easily be provided with a copied DMC, it is physically impossible to clone the random surface texture of the component.

German Patent Application No. DE 10 2019 210 580 describes a method for verifying the authenticity of an object, in which a user photographs an object, e.g., a banknote, using a smartphone (app) and shortly thereafter receives a corresponding confirmation from the app if the object is authentic. The texture comparison takes place, for example, in the cloud, where the reference textures are stored in a database and can be used for comparison.

### SUMMARY

A first and most important advantage of the method of the present invention is the translation invariance thereof. This means that the identification is invariant (independent) with respect to a displacement (translation) of a query object in the camera image. In other words: The identification leads to the same result no matter where the ROI (region of interest) is displaced in the second image—of course only if the ROI completely contains the correspondence to the first image region. Translation invariance applies for both axial directions (x,y) of the camera image. The previous need in the related art to be able to reproduce the position of the reference ROI in the query image is no longer necessary. The alignment step required by the fragile fingerprint methods can therefore be omitted with this method.

A second advantage of the present invention is scalability in the sense that the user has the possibility to limit the permissible (x,y) translation. In principle, the method is able to identify an object even if there is only a small overlap with respect to the object between the reference image and the query image. The user can then limit the translation region (in the sense of a search region) to the required size, e.g., 20 pixels in each direction to the left, right, up and down. In this example, the translation vector may be in a 41×41 pixel-sized region. The advantage of this restriction is a saving in computational effort (time), because this increases with the translation region area. However, it increases much less than is the case with conventional fingerprint methods.

These advantages regarding translation allow the application of the method according to the present invention to object types that were previously not manageable with fingerprint methods, e.g., rough cast parts or parts that lack usable visual references (edges, corners, holes, etc.) that would enable a suitable alignment (preprocessing step to uniformly align the query image).

A third advantage of the method according to the present invention is that its similarity measure (which will be described below) proves to be much more discriminatory in practice than the Hamming distance measure of the fingerprint methods.

A fourth advantage is that the method according to the present invention works with small image dimensions in practice. Even for the most difficult object types, image dimensions of, for example, 400×400 pixels are more than sufficient. In practice, image dimensions of approximately 50×50 pixels are often sufficient for reliable identification.

In a first aspect, the present invention relates to a computer-implemented method for ascertaining whether a specified image detail of a first image occurs in a second image. The image detail has either been preselected manually or determined in some other way. The image detail is small, especially relative to the first image; particularly preferably, the image detail comprises 50×50 pixels up to 400×400 pixels of the first image.

According to an example embodiment of the present invention, the method begins with ascertaining image features for a plurality of pixels within the specified image detail. The image features are ascertained according to a specified calculation rule, wherein the calculation rule calculates the image feature depending on pixel values of the adjacent pixels. For example, an environment with 3×3 adjacent pixels up to 127×127 pixels around the pixel in question can be used for the image feature. The calculation rule outputs a unique value and thus the image feature is unique, i.e., the image feature characterizes the pixel arrangement of the pixel under consideration including its surroundings. The calculation rule is chosen in such a way that the unique image feature is retained with a high degree of probability even if the pixel values are at least slightly changed, e.g., due to sensor noise or differences in illumination. This means that the calculation rule does not have to ascertain a unique value for each pixel combination, but uniqueness should be given with a high degree of probability. Preferably, the calculation rule is translation invariant at least to a small extent.

This is followed by obtaining the second image, in particular a detail (region of interest, ROI) of the second image, which is smaller than the second image but at least as large as the detail of the first image.

This is followed by ascertaining image features for a plurality of pixels of the second image or within the ROI. The image features of the first and second images are calculated the same way, i.e., the same calculation rule is used for the image features.

This is followed by a comparison of the ascertained image features of the second image with the ascertained image features of the first image, preferably taking into account not only the values of the image features but also their arrangement relative to one another in the image in question. If a group of at least two dissimilar image features is found in the second image, which features are arranged in the same or almost the same way as an identically valued group of dissimilar image features in the first image, it is output that the specified image detail is present in the second image; otherwise, it is output that the specified image detail is not present in the second image.

A special feature of the method according to an example embodiment of the present invention is that a rotationally symmetrical area, in particular a ring-arc-shaped or circular area, is determined from the second image and in particular the first image and this area is transformed into a quadrangular, in particular rectangular quadrangular, area and that the image features of the pixels of the second image and in particular of the first image are calculated within the transformed area. The rotationally symmetrical/annular-arc-shaped area can be transformed into its polar coordinate version with given dimensions height×width by a given center point as well as a radius “start” and radius “end” and preferably a start/end angle. Accordingly, it should be noted that the specified image detail comes from the transformed area of the first image.

It is possible that the adjacent pixels of the rotationally symmetrical area which are now located within the quadrangular area separately from each other at opposite ends of the quadrangular area are included in the calculation rule when calculating the image features of these originally adjacent pixels. In other words, it can be provided that the quadrangular area is supplemented at its ends with, for example, a copy of the pixels of the opposite ends.

According to an example embodiment of the present invention, it is proposed that after the step of ascertaining the image features of the first image, an assignment step takes place in which each of the image features is assigned a relative position of the pixel for which the relevant first image feature was ascertained with respect to a reference position of the specified image detail. The reference position can be a center point of the image detail. In the step of comparing, if the values of the image features of the first and second images are identical, the assigned relative position of the image feature of the first image is captured and a pixel position of the pixel of the second image for which the identical image feature is present is stored in an adjacency matrix so as to be displaced in relation to said relative position, in particular at this displaced pixel position. This is followed by a pixel-by-pixel aggregation of the displaced, stored positions, wherein if a predominant plurality of the output positions with respect to a confidence measure are present at a substantially identical pixel position of the second image, it is output that the specified image detail is present in the second image; otherwise, it is output that the specified image detail is not present in the second image.

Substantially the same pixel position can be understood as a deviation of +/−2, 3 or 4 pixels or more.

Optionally, this can be followed by an output step in which the pixel position with the most counts after aggregation is output as the position of the image detail in the second image.

Optionally, the aggregation can be smoothed to facilitate the evaluation, whereby a clear maximum can be achieved at a unique location and at the same time insignificant secondary maxima are suppressed.

Preferably, according to an example embodiment of the present invention, the image features are used to address a lookup table, wherein the assigned relative position for the relevant address is stored. Optionally, the lookup table contains a weighting in addition to the relative positions, wherein the weighting changes, in particular decreases, with increasing distance of the image feature position from the reference position. The weighting can also be used during aggregation to perform the aggregation in a weighted manner.

In the event that there is a plurality of image details, each of the method steps explained above is carried out for each of the different image details. Preferably, the image details are evenly distributed over the object texture in the first image, e.g., evenly distributed on a circle.

Furthermore, according to an example embodiment of the present invention, it is proposed that a plurality of the image details have a specified arrangement relative to one another within the first image, wherein in the step of comparing, in addition to the stored positions, it is ascertained how these positions are arranged relative to one another and the two arrangements are compared with one another. The arrangement can be given by defined distances between the positions or topological patterns.

When comparing topological patterns, it is preferable to compare only the structure of the pattern and not to consider the orientation of the pattern. The advantage here is that an additional independent decision criterion of a topological arrangement effectively makes it more reliable to say whether the object depicted in the images is identical.

According to an example embodiment of the present invention, it should be noted that the step of ascertaining the image features of the pixels of the second image takes place immediately after capturing the second image, preferably in a computing unit, and is transmitted to a server which transmits a signal back depending on the comparison. Preferably, the image features of the image detail have already been ascertained in the cloud or transmitted there and are only compared in the cloud with received image features. As an alternative to the cloud, the method can be carried out locally.

Preferably, in the first aspect of the present invention, the first and second images depict a surface of the same workpiece.

According to an example embodiment of the present invention, the first and second images may have been captured with the same camera or cameras. There are no special requirements for the cameras used to capture the two images; a low image resolution is sufficient. In both cases, the recording setup should be as similar as possible in terms of choice of lens, distance to the selected area of the object, focusing thereon, type and arrangement of lighting. The exposure time and lighting intensity should be selected so that the relevant image does not show any significant motion blur and that it is neither too dark nor overexposed. If it is not possible to use two identical camera arrangements, the differences can be subsequently compensated for by image processing. For example, if the second camera has a different distance or a different focal length or a different pixel format (pixel pitch) than the first camera, the resulting scaling difference can be compensated by image scaling, so that the viewed area of the object is then approximately the same size (in pixels).

In further aspects, the present invention relates to a use of one of the methods of the first aspect for checking whether a surface image of an object belongs to a given object. Preferably, the query object is compared with all reference objects. The best match (highest overall confidence value) is then ascertained. If this value is high enough (above a threshold) the match is output. However, if the best overall confidence value is not high enough, no match was found. The query object is either a fake or has not yet been recorded as a reference.

In further aspects, the present invention relates to a use of one of the methods of the first aspect for verifying an authenticity of a product.

In further aspects, the present invention relates to a device and a computer program, each of which is configured to carry out the above methods, and to a machine-readable storage medium on which this computer program is stored.

Example embodiments of the present invention will be explained in detail below with reference to the figures.

### BRIEF DESCRIPTION OF THE DRAWINGS

FIG. 1 schematically shows images of produced components, each having a plurality of image regions A-L in a grid-like arrangement.

FIG. 2 schematically shows an exemplary embodiment of a method for the recognition of image regions, according to the present invention.

### DETAILED DESCRIPTION OF EXAMPLE EMBODIMENTS

There is already a plurality of methods for markerless tracking based on surface texture, for example the so-called track & trace fingerprint from the Fraunhofer-Institut für Physikalische Messtechnik [Fraunhofer Institute for Physical Measurement Techniques]. This technology is based on the fact that many semi-finished products or components have a microscopically individually embossed surface texture or color texture. A defined region of the component is selected and recorded in high resolution with an industrial camera. A numerical identifier is calculated from the image capture with its specific textures and their position and assigned to an ID. This pairing is stored in a database together with other data, such as measurement or creation data. For later identification, the entire process is repeated and a data comparison returns the ID and other individual features of the component.

The aforementioned “calculated numerical identifier” is hereinafter referred to as a fingerprint. The fingerprint can be imagined as a number having many digits or, equivalently, as a long bit sequence.

During the aforementioned database comparison, the current fingerprint is compared with previously recorded reference fingerprints, and the degree of difference is ascertained in each case. Ideally, exactly one reference fingerprint is found that shows little difference from the query fingerprint, while the comparison with all other reference fingerprints provides a high degree of difference. It is exactly then that the identification is considered successful.

The difference between the physical reference object and the physical query object is ascertained solely from the pair of fingerprints, for example as the Hamming distance of the two bit sequences or in accordance with another distance measure definition.

At this point, the present invention differs particularly clearly from the related art.

The methods from the related art for traceability and trademark protection are based on the creation of a so-called fingerprint, which describes the individual texture properties for an ROI (region of interest) of the object, for example in a bit string of fixed length, which can be several thousand bits.

The texture comparison is then performed as a comparison of the fingerprints. For example, the Hamming distance is calculated between the fingerprint of the reference object and the fingerprint of the query object, i.e., they are compared bit by bit, and the differences are counted. The smaller the Hamming distance (ideally 0), the more similar the objects are.

If the Hamming distance is normalized with the length of the bit string, a similarity value between 0 and 1 is obtained, although in practice the values only use the range 0 to approximately 0.5, because with statistical independence of the bit strings only approximately half of the bits differ.

The comparison of fingerprints, e.g., using Hamming distance, has the advantage of speed, so many comparisons can be carried out in a short time.

However, it also has a significant disadvantage, because the result of the fingerprint comparison is not translation invariant. If, for example, the fingerprint for the query object is not created at the same location (ROI) as the reference object, but offset by 20 pixels, for example, it will have virtually no similarity to the reference fingerprint.

The texture comparison in this case therefore gives a wrong result: although it is the same object, the texture-image pair is wrongly classified as dissimilar.

In practice, this unfavorable behavior due to the lack of translation invariance of the fingerprint methods has led to a large amount of additional effort regularly having to be made to ensure that the position of the ROI in the reference and query images is as identical as possible, because deviations of just a few pixels are no longer tolerable.

For some object types, the geometry of the part makes it possible to mechanically place the object in a reproducible position (pose) with respect to the camera. This creates additional effort (robot gripper arm to grip the object, placing the object in a suitable template in front of the camera, gripping the object again and moving it back, time required, costs, sensitivity). For other object types, these geometric conditions are not met and visually prominent features of the object type must be utilized to make the ROI reproducible, e.g., the position of holes, grooves, corners, edges, etc. This also creates additional effort (adaptation of image analysis algorithms to the component, application by specialists).

However, there are also object types for which neither one nor the other method works to reproducibly retrieve an ROI.

This applies, for example, to objects of a coarser nature, such as metal castings, which do not have defined edges, but rather have strongly beveled and rounded edges to facilitate removal from the casting mold and, possibly making things even more difficult, random casting burrs.

Even with flat object types such as sheet metal, paper, cardboard, fiber-reinforced plastic panels, etc., the reproducibility of the position of ROIs can be difficult or even impossible, especially if the edges are bent, folded, punched or trimmed during processing, thus losing the possible visual references.

Minor uncertainties in the position of the ROIs can be compensated for by creating a plurality of fingerprints having slightly offset ROI positions (e.g., displaced pixel by pixel). However, this multiplies the effort for fingerprint creation and comparison accordingly, usually even exponentially, because there is uncertainty in both axial directions (x,y). Greater uncertainties regarding the location of the ROIs in practice cannot be covered.

In order for the fingerprint methodology in the operation to work, both steps must always be successful, i.e., the alignment step (also called matching or alignment step) and the fingerprint comparison step.

What makes this particularly difficult is that the alignment step that must be carried out at each camera station (first station for initial capture and a number of further stations for identification) for ROI alignment must always produce the same result. This can hardly be guaranteed in practice, especially in continuous operation.

Accordingly, fingerprint methods are considered fragile in practice and are therefore unpopular with users. For example, a small displacement of the camera relative to the storage template can result in the components no longer being identifiable at this identification station and production therefore coming to a standstill.

The following confidence measures will be introduced which evaluate the trust in the quality of a found correspondence.

Confidence measure q_{B} is mathematically defined as:

$${q}_{B} = \frac{{p}_{1}}{{p}_{2}} - 1 .$$

In this context, p₁ is the height of the best peak and p₂ the height of the second best peak. Peak here means the value of the global or local maximum in the adjacency matrix or in a further processed form of the adjacency matrix.

A preferred further processing of the adjacency matrix is to smooth the adjacency matrix after the accumulation (collection of the adjacencies) is completed. A suitable smoothing filter is, for example, a two-dimensional Gaussian smoothing filter.

Because p₁≥p₂ is always satisfied, it follows that q_{B}≥0.

The confidence measure q_{B} is suitable for assessing, for example from a single image comparison (1-to-1 comparison: 1 query image or query ROI against 1 reference image region), whether the correspondence search was successful or not. If the correspondence was found, q_{B} is large (e.g., q_{B}=11); otherwise, q_{B} is small (e.g., q_{B}=0.1).

In an alternative embodiment for the confidence measure, the subtraction of the 1 can be omitted.

An alternative, even simpler confidence measure q_{A} is: q_{A}=c·p₁ with an optional constant c. The height of the best peak is used as a confidence measure.

This again gives the value of the global maximum in the adjacency matrix or in a further processed form of the adjacency matrix (e.g., according to smoothing filtering). The optional constant c can be used to set the range of values of q_{A} for example to 0≤q_{A}≤1.

The confidence measure q_{A} has the advantage that the ascertainment of the second peak p₂ can be dispensed with, which means a saving of computing operations. On the other hand, this also eliminates the comparison value for standardization.

However, this apparent disadvantage becomes irrelevant in a 1-to-N comparison (1 query image against many (N) reference images, as will be discussed in more detail later), because there is usually a hit that is characterized by a high q_{A} value, compared with N−1 non-hits, all of which have low q_{A} values. This information is completely sufficient to determine the winner, so that the height of the second best peak in the same query image is dispensable information.

The simpler confidence measure q_{A} will therefore be the preferred confidence measure below.

For a reliable function of the present invention, a camera is preferably used which captures a two-dimensional image in the form of gray values or multi-dimensional values (color values) of a (partial) surface of the object (so-called texture capture) and this image is as reproducible as possible from camera to camera. In other words, the image should look as similar as possible. Differences that are easily correctable, for example by rotating, scaling, displacing or adjusting the brightness of the image content, do not pose a problem.

In order for the image content of the two shots of the same object to be as similar as possible in this sense, the two recording setups should be as similar as possible or at least coordinated with each other. This applies in particular to lighting.

This is relatively easy to achieve with objects having a matte surface, because the incident light is widely diffused and thus the image of the object hardly changes if the lighting position varies slightly. For objects having a highly reflective surface, e.g., ground or brushed and then chrome-plated steel, the image depends strongly on the position of the light source, especially if it is punctiform. In order to ensure that both recording setups still produce reproducibly similar images of the object, it is highly advisable to choose a lighting system in which the light hits the surface as evenly as possible from all directions (diffuse lighting). This is achieved, for example, with dome lighting close above the object, where the inside of a matte white hemisphere is illuminated so that indirect lighting is as undirected as possible. The camera is located inside the hemisphere or looks into it through a hole in the region of the hemisphere's axis of symmetry.

Especially for such difficult surface types, it can be useful to calculate the texture image from a plurality of consecutive images captured by the same camera under different lighting conditions.

For example, four images can be captured in quick succession, with only one quadrant of a ring- or dome-shaped diffuse lighting switched on at a time. Suitable, well-known methods are, for example, shape from shading or photometric stereo.

For example, with shape from shading, a so-called texture image is calculated that describes the reflectivity of the surface, as well as a curvature image that describes the local curvature. Both images are suitable for this invention, either independently or in combination, because they each provide a reproducible image of the object in which the dependencies on the lighting have been factored out.

Various methods are described in the related art for retrieving an image region from a first image in the second image, e.g., in German Patent Application No. DE 10 2019 210 580.

One of these methods first defines a small outline of an image detail, such as a square or circular or polygonal outline.

The feature points are located within this outline: these are image features formed from their respective surroundings, which are represented, for example, with 16 bits each. Such an image feature represents a compact representation of a more or less local image content. Overall, a larger total image region contributes to the totality of the features formed. To calculate the image feature for a given pixel, a latch descriptor can be used: G. Levi and T. Hassner, “LATCH: Learned arrangements of three patch codes;” in IEEE Winter Conference on Applications of Computer Vision (WACV), pages 1-9, 2016. However, it should be noted that there are many other conventional methods for calculating these features.

The square in this exemplary embodiment is 50×50 pixels in size and contains 2500 feature points. In other words, the feature density here is 1 feature per pixel. But it could also be higher or lower, e.g., 4 features per pixel or 1 feature per 9 pixels.

The relevant feature value (with, for example, a word length of 16 bits) serves as an address in a lookup table, in which the feature position in the image relative to a reference position in the image is then entered, and optionally also further information, e.g., a weight.

At the latest when all 2500 feature points have been entered into the table (a smaller number is usually sufficient), the processing of the image region under consideration from the first image is thereby completed.

The second image is the image for which the position corresponding to the reference position is to be ascertained. The search region for this position can cover the entire second image. The features are then generated accordingly for the entire second image. Alternatively, the search region only covers a part of the second image (ROI). Then, for the second image, features are generated for the area corresponding to the enlarged ROI, which is enlarged by the allowable displacement, for example by 20 pixels in each direction, to the left, right, up and down. For the second image, either exactly the same methodology for feature calculation is applied as for the first image or an adapted methodology is applied that appropriately takes into account the change in the state of the texture, e.g., from dry and clean to soaked with oil.

In this case, prior knowledge can be used which describes, for example, the change in texture in the image during the transition from dry to oil-soaked or vice versa, for example statistically, for example in the form of a composite distribution density of the local contrasts (or color values) between the two states.

In this exemplary embodiment, the feature density in the second image is again 1 feature per pixel. It may also be higher or lower and does not have to match the feature density of the first image.

The generated features from the second image are again used to address the lookup table, but this time in a read-only manner. As described above, starting from the current feature position in the second image, an adjacency is given at a relative position ascertained using the lookup table and entered into an adjacency image. This can be done for each feature in the search region, wherein the adjacency results are collected (accumulated) in the adjacency image, preferably additively or weighted additively.

In a preferred embodiment, the size of the adjacency image approximately corresponds to the size of the search region. The adjacency image selected can also be smaller or larger. However, the selection does not have to be larger than the range of the relative position when the adjacency is output. This range depends on the size of the first image region and the relative location of the reference position—or, in other words, on the limitation of the length of the 2D vector.

In the method for retrieving an image region, in the case of a correspondence in the adjacency image, a very distinct and locally very focused cluster point results, the position of which corresponds to the sought position, i.e., the correspondence of the reference position from the first image in the second image. By evaluating the cluster point, e.g., in the sense of ascertaining its maximum position or its center of gravity position, the desired correspondence position can be ascertained with sub-pixel accuracy if this is desired or required. Depending on the resolution of the camera, this can correspond to sub-millimeter accuracy.

The ascertained position information can be used advantageously in different ways: From the difference between the reference position in the first image and the found position in the second image, it can be ascertained how the pose between the camera and the object differs between the two camera stations. Statistics can be ascertained from this. The mean value provides information about the differences from camera station to camera station that it may be desirable to correct. The deviation from the mean value, e.g., expressed as standard deviation, provides information about how the poses vary from object to object. These position fluctuations can be caused by variations in the gripping of the robot or by differences in the shape of the parts. For example, in non-deburred cast parts such variations can be large.

The statistics can also be helpful for parameterizing the search regions. As described above, it may make sense not to fully exploit the degree of freedom of translation, but to configure a smaller search region in favor of less computational effort. To avoid missing any correspondence, however, it should not be set too low.

If a plurality of correspondences are searched for each image pair, conclusions can be drawn from the arrangement of the correspondence positions found and the confidence of the classification can be further improved.

The following section looks at how advantages can be gained from the optional use of multiple reference image regions.

The multiple reference image regions are placed in the reference image. For example, M=12 reference image regions are placed in relation to the reference image in such a way that they preferably capture the parts of the object surface that enable differentiation. Noise-like textures that arise from random processes are particularly suitable for recognizing individual objects. In contrast, regions that look almost the same for every object would be unsuitable. Unsuitable areas for positioning the reference image regions are, for example, overexposed image regions that are so bright that the camera can no longer resolve details, or very dark image regions where the signal-to-noise ratio is low, so that the image signal is largely determined by sensor noise (which of course cannot contribute anything to identification).

Furthermore, unsuitable areas can be, for example, nearly homogeneous image regions where the signal is approximately constant or only slightly varies locally, thus providing little or no information for identification, or very blurred image regions that lie clearly outside the focal plane or focal area of the camera, or image regions that look the same for every object and therefore do not serve to distinguish them, e.g., edges, corners, holes. This also includes shadow edges caused by the lighting.

Also unsuitable are areas that are destroyed during the tracking of the object or that undergo serious changes that make tracking impossible, for example areas that are milled, ground or sandblasted, or areas to which opaque paint is applied or which are otherwise covered so that they are no longer visible later.

The reference image regions are usually defined once for a component type after the recording setup (camera, lighting, pose, image resolution, image detail) has been determined. This definition is usually the only parameterization step that is then required. The definition of the reference image regions then normally applies to all objects of this component type. It can be carried out by an expert or in an automated manner.

For example, the definition can be carried out by an expert, namely with M=12 reference image regions, the centers of which are placed on a circle at equal angular intervals of 30°, like the hours on the face of a clock. This arrangement is suitable, for example, for a circular or annular object surface. The reference image regions are preferably located within well-focused, randomly textured areas. Edges and blurred image regions are avoided.

Overlaps of the reference image regions are permissible, but should be avoided, because there is no additional benefit from the extra effort.

As an overall confidence measure q_{Ges} when a plurality of image regions is used, in the simplest case the sum or average of the M confidence measures are formed, for example:

$${q}_{G e s} = \frac{1}{M} {\sum }_{i = 1}^{M} {q}_{i} ,$$

wherein the individual confidence measure qᵢ here can preferably be formed according to q_{A} or according to q_{B} or according to another rule.

The ability to place a plurality of small reference image regions independently on suitable partial regions, each with a suitable surface texture, and thus to achieve an optimized adaptation to the component type in terms of distinguishability with little effort, represents an advantage of this method.

The use of an expert to determine the reference image regions may be disadvantageous due to cost or availability reasons.

Alternatively, there is the option to automatically optimize the image regions. For this purpose, a training is planned that requires a very small number of objects, e.g., N_{R}=10 pieces, but at least N_{R}=2 pieces.

In the following, it is assumed that of each of these N_{R} training objects there is one reference image (hence the index R) and of N_{Q}≤N_{R} thereof also one query image (index Q).

This 1≤N_{Q}≤N_{R} is fulfilled, or in other words, ideally, there is also a query image for each object, thus N_{Q}=N_{R}; if necessary however, a single query image is sufficient, i.e. N_{Q}=1.

For example, the training runs as follows:
1. A designated number M of reference image regions are initially placed, e.g., randomly or regularly, e.g., as tiling.
2. This placement is applied to all N_{R} reference images. The method for the pairwise comparison of the N_{Q} query images is then applied to the N_{R} reference images. This creates N_{R}×N_{Q} similarity values that are converted into a similarity matrix of size N_{R}×N_{Q} in which the column index corresponds to the query numbering and the row index corresponds to the reference numbering.

In the case of N_{R}=N_{Q} and if the order is identical, the correct assignments would be on the main diagonal.
3. The similarity matrix is evaluated. The goal is to optimize the similarity matrix, achieving the maximum value in each column for the correct assignment (usually on the main diagonal), while all other values in the column are as small as possible. The measure can, for example, be the quotient or the difference between the highest similarity and the second highest similarity (in the relevant column), averaged over all columns. This results in an overall rating number for the placement setup, which needs to be maximized.
4. If the total rating number has reached a maximum or has exceeded a threshold, the optimization is complete and the ascertained parameters are thus optimized. Otherwise the process continues.
5. The setup is varied. This includes the change of: positions of the individual reference image regions (i.e., their position within the image), and/or dimensions of the individual reference image regions (e.g., for rectangular or elliptical shapes: width, height, aspect ratio, angle), and/or number of reference image regions.

It should be noted that overlaps of the reference image regions are again avoided whenever possible.

Of course, the usual methods in optimization can be used to accelerate this training or to lead it to the global optimum. For example, gradients are calculated to ascertain and give preference to the parameters that have the greatest influence on the overall rating number.

It is advantageous to also include the computational effort in the overall rating (less computational effort leads to a better rating number). This automatically results in the number and dimensions of the reference image regions not being larger than necessary and not overlapping.

Objects are often constructed to be substantially rotationally symmetrical. Then there is often no way to reproducibly position the object in front of the camera at the same angle (around the rotational symmetry axis). A notch on the side, for example, would provide clarity and thus help, but such an aid is not available for some object types.

For such and similar objects, which in this sense are ambiguous with respect to rotation about an axis, the present invention has a strong advantage over the related art, because their translation invariance in two directions can be converted into a tangential invariance and an axial invariance. Particularly important here is the tangential invariance, which can also be called rotation invariance.

For this purpose, it is proposed that a detail from the image, for example a circular area, is digitally unrolled. To do this, the two radii of the circular disk and the position of its center point in the image must be defined. This should at least approximately coincide with the intersection point of the rotational symmetry axis in the image.

The parameters for cutting out the circular disk are either known in advance or can be ascertained from the image. In particular, it may be useful to recalculate the center point for each image if it varies, e.g., based on the estimation of the center of symmetry. An approximate estimate, e.g., accurate to a few pixels, is sufficient.

When the circular disk is digitally unrolled, it is cut open and unrolled into a rectangular shape. The pixel values (gray values, color values) are warped accordingly.

It should be noted that during the unrolling, not only areas such as circular arcs can be unrolled, but of course the area to be unrolled can also be an inner/outer cylinder or an inner (truncated) cone or an outer (truncated) cone. Even shapes such as a barrel shape, dumbbell shape or wave shape are possible. This means that the unrolling can generally be used on rotationally symmetrical areas.

At the intersection line, it is possible to imagine the rectangle continuing cyclically on the right and left, because these two ends belong together. Accordingly, all image processing operations and further processing steps beyond this cutting line can be continued without interruption.

After the unrolling of the circular-disk-shaped image content into a rectangular image, the method can be applied as usual: in other words, an unrolled query image is compared with an unrolled reference image.

If the described principle of cyclical continuation is consistently followed, the result of the identification according to the present invention is independent of where the radial cut was made on the circular ring.

Assuming that the round component is in an unknown angular position, the unrolling process transforms the unknown angular position into an unknown horizontal translation. However, the algorithm is invariant against these. This means that the result is independent of the horizontal translation. The object can therefore be identified in its unrolled form, despite the unknown angular position. Thus, the translation-invariant method becomes a rotation-invariant method by virtue of the unrolling.

In the unrolled image, vertical translation invariance is also present. This means that vertically displaced correspondences are also found. The vertical translation invariance is mapped into an invariance in the radial direction. This is also extremely useful because it can compensate for an inaccurately placed center point. In other words, if the estimate of the center of symmetry was flawed, e.g., misplaced by 5 pixels, and the unrolling of the disk occurs accordingly around the wrong center point, this does not pose a problem because the (then vertically displaced) correspondences can still be found. This brings a further enormous gain in robustness to the method.

In summary, this means in other words that for the identification of substantially rotationally symmetrical objects in practice, their angular position may be arbitrary and unknown when the image is captured and that an approximate knowledge or estimation of the position of the axis of rotation or the center point is already sufficient.

This important advantage over the related art is made possible by the given two-dimensional translation invariance of the method, which can be converted by unrolling into rotation invariance and invariance in the radial direction.

The invariance in the radial direction is not a true invariance in the mathematical sense, because the unrolling is a nonlinear mapping in which there is a scaling factor dependent on the relevant radius. An error in the position of the center point translates into a scaling error. In practice, however, this apparent problem has proven to be negligible and therefore irrelevant.

As soon as a plurality of reference image regions is used per image, an optional additional possibility arises to further increase the confidence in the identification.

This is because the M reference image regions are located in a specific arrangement in the reference image. It is then expected that the correct correspondences found in the query image are in the same or a similar arrangement. This can be checked to create an additional or alternative quality measure.

If the arrangement corresponds to expectations, the confidence is high; deviations from expectations reduce the confidence accordingly.

If not all M possible correspondences can be found, e.g., because the object has suffered damage in places, at least the remaining part of the correspondences should still be in the expected partial arrangement. This should still lead to a relatively high level of confidence.

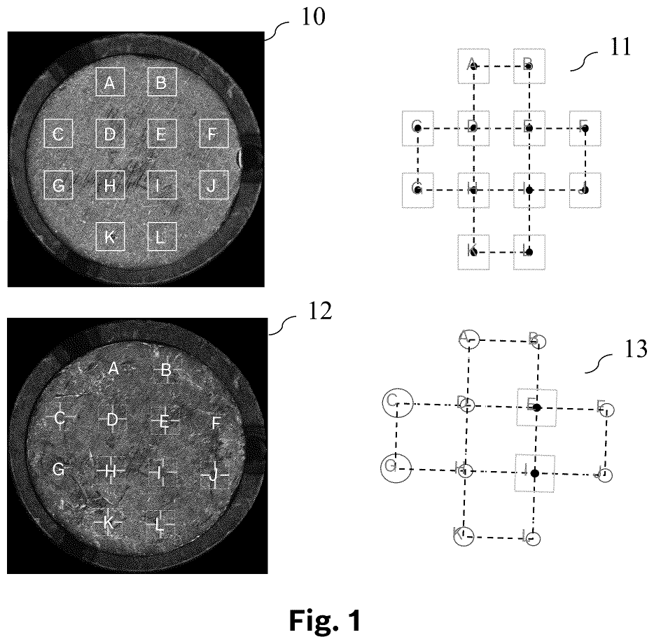

This is illustrated in FIG. 1. On the reference object 10 M=12 image regions are defined, marked here with the letters A-L, which are to be used for texture-based identification. The center points of the image regions are located in a predefined arrangement 11, which is also shown as a graphic to the right of the image. In this case, it is a grid-shaped arrangement with a rectangular grid with constant grid spacing (in both dimensions). Of the 4×4 grid positions that are possible here, the 4 corner positions are not used.

Other arrangements of the image regions are possible, e.g., on a circle or other geometric shapes.

At the time of the query image, the same object 12 now shows damage on the surface, which makes identification difficult. Other factors, such as changes in recording conditions, can make things even more difficult.

All this leads to the fact that some correspondences, e.g., G, are not retrieved at all and some correspondences, e.g., F, have a very low confidence or a strongly reduced confidence, e.g., B.

It is proposed in particular for such difficult cases (which may be significantly more difficult than shown here) to have the possibility of introducing an additional check in which the consistency of the arrangement is checked in order to derive an additional evaluation metric.

This will be explained using the following illustrative example. The correspondences E and I found here are considered to be particularly strong. The positions of these correspondences, for example, can then serve accordingly as anchor points to anchor the known arrangement, in this case the grid, as shown in arrangement 13 on the right. This leads to a slight rotation of the grid to the right (because the object in the query image is rotated accordingly). A slight scaling (reduction or enlargement) of the grid may also be necessary here.

Based on the grid anchored in this way, all other expected correspondence positions can be ascertained, e.g., those of B. If this correspondence is actually found within a radius around this expected position, this should have a positive effect on the combined confidence, thus increasing it. The radius takes into account, for example, the expected measurement inaccuracies, image distortions, numerical inaccuracies and error propagation. The radius can have a fixed or variable radius. Optionally, the circumference grows with the distance to the anchor points, which can also be seen in arrangement 13, where the circumferences have different diameters. The circles optionally also grow more the closer the anchor points are to each other (reduced leverage, not shown graphically here).

The circles are not to be taken literally, i.e., they do not have to be circular areas, but can also have a different shape. Elliptical shapes are particularly relevant because they result from the error calculation.

The calculation of the combined confidence can then, for example, be made as follows:
1. Choose two found correspondences, e.g., E and I, to anchor the grid (equivalent to expected arrangement) at their positions, specifically by appropriately displacing, scaling and rotating the grid.
2. Check all other found correspondences A-D, F-H, J-L} to see if they fit the anchored grid, e.g., if they lie within their particular expected radius.
3. In the simplest case, count the fulfillment of expectations. A count value from 0 to M−2=10 could arise as a new confidence measure, wherein the anchor points themselves were not counted.

In an improved variant, counting would be replaced by a summation of the M individual confidence values, each ascertained according to q_{A} or q_{B}, namely only for the correspondences that are within the relevant area. Optionally, the individual confidence values of the anchor points can also be added.

The formula for this could be, for example:

$${q}_{G e s} = \frac{1}{M} {Σ}_{i = 1}^{M} {w}_{i} \cdot {q}_{i} ,$$

wherein wᵢ=1, if the i-th correspondence is within the expected radius or it is an anchor point; otherwise, wᵢ=0.

In a further improved variant, the radius criterion would be defined more subtly, i.e., not as a yes/no decision (is within the radius or not), but with an evaluation of the distance of the respectively found correspondence position from the relevant expected position. For example, with a maximum value for a direct hit, a medium value for a slightly larger distance, and approximately 0 for too large a distance.

The formula for q_{Ges} is suitable for this, but not with a binary weighting factor, rather, with a scalar weighting factor wᵢ, which evaluates the position of i-th correspondence.

As a value of wᵢ the sampling of a two-dimensional correlated or uncorrelated Gaussian density or a two-dimensional conical density function can be used, in each case with its maximum at the expected position. The evaluation number wᵢ obtained by sampling of the density function at the location of the correspondence found can be multiplied by the relevant individual confidence value qᵢ (e.g., peak height). This up to M−2=10 products here are added again. Optionally, the anchor points can also be included in the total, preferably with the direct hit rating.

Optionally, the latter steps can be repeated with all other possible anchor points, for example next with anchor points C and L. The farther the two anchor points are from each other, the greater the leverage for anchoring the grid, which is advantageous.

These permutations avoid the risk that incorrect anchoring due to incorrect correspondence leads to an inappropriately poor overall rating. Of all the total confidences q_{Ges} obtained by permutation, it is therefore preferable to continue using the one with the highest value reached, because it is most likely that the underlying anchoring was correct.

For the exemplary embodiment considered here (with M=12 image regions), it is easily possible to consider the entire set of possible permutations. If only a subset of the permutations is to be considered, it is advantageous to prefer anchor points having high individual confidence values and long levers.

So far, only the case with two anchor points has been considered, which already allow the adjustment of rotation and scaling between the reference and query image. However, it is also possible to work with a different number of anchor points, e.g., three or four. For example, this even makes it possible to allow and take into account different camera perspectives on the object surface. This gives the user more freedom when installing the system. For example, he no longer has to ensure that the viewing direction of the camera at the relevant station is aligned perpendicularly to the object surface, but oblique viewing angles and even handheld camera operation are also possible.

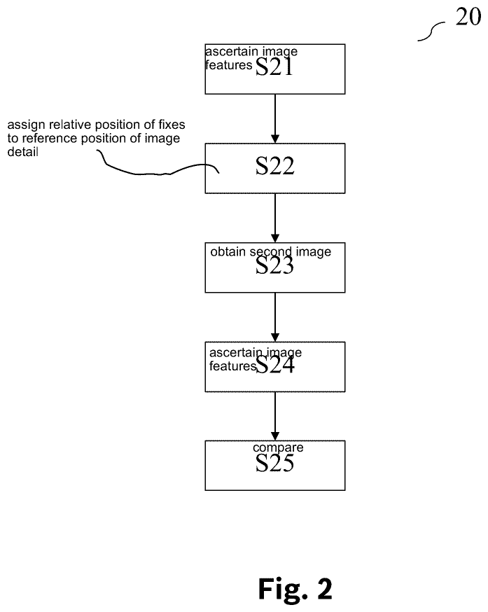

FIG. 2 shows a flow chart of a method for recognizing image regions.

The method begins with ascertaining (S21) image features for a plurality of pixels within the given image detail.

Optionally, an assignment S22 is also carried out. For each of the image features, a relative position of the pixel for which the relevant first image feature was ascertained is assigned in relation to a reference position of the given image detail.

This is followed by obtaining (S23) the second image, wherein a rotationally symmetrical area is determined from the second image and this area is transformed into a rectangular area, and ascertaining (S24) image features for a plurality of pixels of the second image. The transformation was also performed for the first image as explained above.

This is followed by a comparison (S25) of the ascertained image features of the second image with the ascertained image features of the first image to ascertain whether the two have an identical value. If at least one pair of identical image features is present, it is output that the specified image detail is present in the second image; otherwise, it is output that the specified image detail is not present in the second image. It should be noted that for image features that are, for example, only conditionally unique, there should preferably be at least 2 or more pairs of identical image features. Preferably, the majority of pairs of identical image features are located at the same position in the adjacency matrix.

If step S24 has been carried out, the assigned relative position of the image feature of the first image can be used and a pixel position of the pixel of the second image for which the identical image feature is present can be stored so as to be displaced in relation to said relative position in the step of comparing (S25) if the values of the image features of the first and second images are identical. As explained above, these specific positions can be understood as adjacency, which are summed up pixel by pixel in an adjacency matrix (adjacency image). Using the adjacency matrix, a position of the image detail in the second image can be determined.

The two most important areas of application for the method shown in FIG. 2 are:

Markerless tracking (traceability) based on the individual surface texture, e.g., of components in industrial production. Trademark protection by using the individual surface texture of products to recognize originals from one's own production and to differentiate/detect third-party products or counterfeits.

In both cases, the naturally occurring texture of a surface of the object is utilized, which has a random character and is physically practically impossible to clone.

The latter property, that random processes create an individual surface texture for each object that cannot be cloned, can be utilized for trademark protection. For this purpose, the texture of each object produced is recorded by the manufacturer at a predefined location (e.g., photographed or scanned) and stored, e.g., in a database in the cloud.

To later verify the authenticity of an object, its texture is recorded again at approximately the same location and a database comparison is performed. If there is a hit in the database, i.e., a clear match of the texture, the object is known and verified as genuine. However, if no match is found during the comparison, the object does not belong to the set of parts recorded by the manufacturer. This is how a fake can be detected.

1-10. (canceled)

11. A method for ascertaining whether a specified image detail of a first image occurs in a second image, the method comprising the following steps:
ascertaining at least one image feature for a plurality of pixels within the specified image detail;
obtaining the second image;
ascertaining at least one image feature for a plurality of pixels of the second image;
comparing the image features of the second image with the image features of the first image to determine whether the two have an identical value, and outputting that the specified image detail is present in the second image based on at least one pair of identical image features is present, otherwise outputting that the specified image detail is not present in the second image;
wherein the image features are ascertained depending on pixel values of adjacent pixels, and
in the second image, a rotationally symmetrical area is determined and the area is transformed into a quadrangular area, and the image features of the pixels of the second image are calculated from pixels within the transformed area.

12. The method according to claim 11, wherein after the step of ascertaining the image features of the first image, a step of assigning takes place in which each image feature of the image features of the first image is assigned a relative position of the pixel for which the first image feature was ascertained with respect to a reference position of the specified image detail, the assigned relative position of the image feature of the first image being used and a pixel position of the pixel of the second image for which the identical image feature is present being stored so as to be displaced in relation to the relative position in the step of comparing when values of the image features of the first and second images are identical, and a pixel-by-pixel aggregation of the displaced, stored positions being performed, it being output that the specified image detail is present in the second image if a plurality of the aggregated positions is present at a substantially identical pixel position, otherwise it being output that the specified image detail is not present in the second image.

13. The method according to claim 11, wherein a plurality of different image details of the first image are specified, the step of comparing being carried out for each of the different image details, an overall confidence measure being ascertained by accumulation of confidences.

14. The method according to claim 13, wherein the plurality of the image details have a specified arrangement in relation to one another within the first image, it being ascertained in the step of comparing, in addition to the aggregated positions, what arrangement the aggregated positions have in relation to one another, and the arrangements being compared with one another, the output as to whether the image details occur in the second image being additionally dependent on whether the arrangements are substantially the same.

15. The method according to claim 13, wherein a number and/or positions and/or dimensions of the image details are ascertained, initially random or specified positions being selected, the method being carried out for all image details for a plurality of first images and with at least one second image, a confidence being ascertained for each pair of first and second images, the number and/or the positions and/or the dimensions being changed using an optimization procedure such that the confidence is as high as possible when the first and second images show the same object and, otherwise, the confidence being as small as possible.

16. The method according to claim 11, wherein the method is used or checking whether a surface image of an object belongs to a specified object, wherein the first and second images depict a surface of the same object, it being output that the surfaces of the first and second images are the same when at least one image detail occurs in the second image.

17. The method according to claim 11, wherein the method is used to verify an authenticity of a product, the first and second images depicting a surface of an identical product, it being output that the surfaces of the first and second images are the same when at least one image detail occurs in the second image.

18. A device configured to ascertain whether a specified image detail of a first image occurs in a second image, the device configured to:
ascertain at least one image feature for a plurality of pixels within the specified image detail;
obtain the second image;
ascertain at least one image feature for a plurality of pixels of the second image;
compare the image features of the second image with the image features of the first image to determine whether the two have an identical value, and outputting that the specified image detail is present in the second image based on at least one pair of identical image features is present, otherwise outputting that the specified image detail is not present in the second image;
wherein the image features are ascertained depending on pixel values of adjacent pixels, and
in the second image, a rotationally symmetrical area is determined and the area is transformed into a quadrangular area, and the image features of the pixels of the second image are calculated from pixels within the transformed area.

19. A non-transitory machine-readable storage medium on which is stored a computer program for ascertaining whether a specified image detail of a first image occurs in a second image, the computer program, when executed by a computer, causing the computer to perform the following steps:
ascertaining at least one image feature for a plurality of pixels within the specified image detail;
obtaining the second image;
ascertaining at least one image feature for a plurality of pixels of the second image;
comparing the image features of the second image with the image features of the first image to determine whether the two have an identical value, and outputting that the specified image detail is present in the second image based on at least one pair of identical image features is present, otherwise outputting that the specified image detail is not present in the second image;
wherein the image features are ascertained depending on pixel values of adjacent pixels, and
in the second image, a rotationally symmetrical area is determined and the area is transformed into a quadrangular area, and the image features of the pixels of the second image are calculated from pixels within the transformed area.
